(19) United States
(12) Patent Application Publication
(10) Pub. No.: US 2024/0034122 A1
(43) Pub. Date: Feb. 1, 2024

(54) VALVE SET INTEGRATED MODULE, THERMAL MANAGEMENT SYSTEM, AND VEHICLE

(71) Applicant: BYD COMPANY LIMITED, Shenzhen (CN)

(72) Inventors: Shibai LI, Shenzhen (CN); Wei JIN, Shenzhen (CN); Min XU, Shenzhen (CN); Meijiao YE, Shenzhen (CN); Yuzhong LI, Shenzhen (CN)

(73) Assignee: BYD COMPANY LIMITED, Shenzhen (CN)

(21) Appl. No.: 18/478,737

(22) Filed: Sep. 29, 2023

Related U.S. Application Data
(63) Continuation of application No. PCT/CN2022/095515, filed on May 27, 2022.

(30) Foreign Application Priority Data
May 31, 2021 (CN) 202110603391.6

(51) Int. Cl. B60H 1/00

(52) U.S. Cl. CPC B60H 1/00885; B60H 1/00485; B60H 2001/2271

(57) ABSTRACT

A valve set integrated module includes a body, a first and a second electric valves. The body is provided with multiple internal flow channels and multiple interfaces configured to communicate the internal flow channels with a heat exchange assembly. The first and second electric valves on the body are in communication with the internal flow channel. The first and second electric valves are both switchable between a blocked/unblocked position and a throttled position. A first end of the first electric valve is in communication with an interior condenser outlet interface. A second end of the first electric valve is in communication with an exterior heat exchanger inlet interface. A first end of the second electric valve is in communication with an exterior heat exchanger outlet interface. A second end of the second electric valve is selectively communicated with an interior evaporator inlet interface or a gas-liquid separator inlet interface.

### CROSS-REFERENCE TO RELATED APPLICATIONS

The present disclosure is a bypass continuation application of PCT International Application No. PCT/CN2022/095515, filed on May 27, 2022, which claims priority to Chinese Patent Application No. 202110603391.6, filed on May 31, 2021, and entitled “VALVE SET INTEGRATED MODULE, THERMAL MANAGEMENT SYSTEM, AND VEHICLE”, which are incorporated herein by reference in their entireties.

### FIELD

The present disclosure belongs to the field of vehicle technologies, and specifically, to a valve set integrated module, a thermal management system, and a vehicle.

### BACKGROUND

A thermal management system is an important part of a vehicle, which is configured to change a temperature environment in the vehicle and cause a driver and passengers obtain a better experience. In order to cooperate with realization of multiple thermal management modes, multiple dispersed valves are usually arranged in the system. The manner results in low flexibility and low integration of the system arrangement, thus taking up more space. In the related art, in order to solve this technical problem, multiple valves are integrated on a frame body, but the integration manner does not reduce use of a valve control assembly and simplify a pipeline arrangement of the thermal management system.

### SUMMARY

A first object of the present disclosure is to provide a valve set integrated module, to solve problems existing in the related art.

In order to achieve the above objective, the present disclosure provides a valve set integrated module, including:
a body, provided with multiple internal flow channels and multiple interfaces configured to communicate the internal flow channels with a heat exchange assembly of an external thermal management system;
a first electric valve and a second electric valve, arranged on the body and in communication with the internal flow channel, the first electric valve and the second electric valve both being configured to be switchable between a blocked/unblocked position and a throttled position; and
a first end of the first electric valve being in communication with an interior condenser outlet interface, a second end of the first electric valve being in communication with an exterior heat exchanger inlet interface; a first end of the second electric valve being in communication with an exterior heat exchanger outlet interface, and a second end of the second electric valve being selectively communicated with an interior evaporator inlet interface or a gas-liquid separator inlet interface.

Optionally, the internal flow channel includes an internal flow channel and an external flow channel. The body includes a first portion and a second portion. The first portion has a first connecting surface. The second portion has a second connecting surface. the first connecting surface is hermetically connected with the second connecting surface; multiple internal flow channels are arranged inside the first portion; and at least one groove is arranged on the first connecting surface of the first portion, and the groove on the first connecting surface and the second connecting surface jointly define the external flow channel.

Optionally, a sectional surface of the groove is U-shaped; and an area of the sectional surface of the groove is greater than 10% of a valve port area of the first electric valve and the second electric valve.

Optionally, the internal flow channel communicated between an interior evaporator outlet interface and the gas-liquid separator inlet interface is a linear flow channel.

Optionally, the valve set integrated module further includes a PT low pressure sensor. The PT low pressure sensor is arranged between the interior evaporator outlet interface and the gas-liquid separator inlet interface.

Optionally, the valve set integrated module further includes an electronic expansion valve arranged on the body. A first end of the electronic expansion valve is in communication with the exterior heat exchanger outlet interface. A second end of the electronic expansion valve is in communication with a plate-type heat exchanger inlet interface arranged on the body.

Optionally, the valve set integrated module further includes a battery pack heat exchanger arranged on the body. An inlet of the battery pack heat exchanger is in communication with the battery pack heat exchanger inlet interface. An outlet of the battery pack heat exchanger is connected with a gas-liquid separator.

Optionally, the electronic expansion valve and the exterior heat exchanger outlet interface are assembled on a same side of the body.

A second object of the present disclosure is to provide a thermal management system. The system includes an exterior heat exchange assembly of the thermal management system and the valve set integrated module in any of the above. The external heat exchange assembly includes multiple of a compressor, an interior condenser, an exterior heat exchanger, an interior evaporator, a gas-liquid separator, a PTC air heater, a blower, and a PTC water heater.

A third object of the present disclosure is to provide a vehicle, including the thermal management system.

The present disclosure designs a valve set integrated module having multiple internal passages. The valve set integrated module can communicate the internal flow channel with the heat exchange assembly of the external thermal management system through different interfaces arranged on the body to form multiple different thermal management circuits, and the first electric valve and the second electric valve integrated on the module control the unblocking/blocking or the throttling of the thermal management circuits, to realize multiple preset thermal management modes. The valve set integrated module designed through the above technical solution can reduce the use of a valve control assembly and simplify connection of a pipeline of the thermal management system while realizing multiple thermal management modes, reduce weight of the vehicle, reduce a cost and a fuel consumption, and save space for arranging the vehicle.

Other features and advantages of the present disclosure will be described in detail in the following detailed description part.

### BRIEF DESCRIPTION OF THE DRAWINGS

The accompanying drawings are intended to provide further understanding of the present disclosure and constitute a part of this specification. The accompanying drawings and the specific implementations below are used together for explaining the present disclosure rather than constituting a limitation to the present disclosure. In the accompanying drawings:

FIG. 1 is a schematic diagram of a thermal management system according to an exemplary embodiment of the present disclosure.

FIG. 2 is an assembly diagram of a valve set integrated module according to an exemplary embodiment of the present disclosure.

FIG. 3 is an exploded view of a valve set integrated module according to an exemplary embodiment of the present disclosure.

FIG. 4 is a front view of a valve set integrated module according to an exemplary embodiment of the present disclosure.

FIG. 5 is a bottom view of a valve set integrated module according to an exemplary embodiment of the present disclosure.

FIG. 6 is a top view of a valve set integrated module according to an exemplary embodiment of the present disclosure.

FIG. 7 is a schematic diagram of arrangement of an internal flow channel of a valve set integrated module according to an exemplary embodiment of the present disclosure.

FIG. 8 is a cross-sectional view of the valve set integrated module in FIG. 5 taken along line A-A.

FIG. 9 is a cross-sectional view of the valve set integrated module in FIG. 6 taken along line B-B.

### DETAILED DESCRIPTION

Specific implementations of the present disclosure are described in detail below with reference to the accompanying drawings. It should be understood that the specific implementations described herein are merely used to describe and explain the present disclosure, but are not intended to limit the present disclosure.

In the present disclosure, without the contrary explanation, the directional terms “inside and outside” refer to inside and outside of a relevant part, unless otherwise stated. In addition, terms “first”, “second” and “third” are only used for distinguishing the description and cannot be understood as indicating or implying relative importance. In addition, in the description of the present disclosure, it should be noted that, unless otherwise specified or defined, the terms “arrangement”, “communication”, “installation” should be broadly understood, for example, may be fixed connection, may also be detachable connection or integrated connection; or the connection may be a direct connection, an indirect connection through an intermediary, or internal communication between two components. A person of ordinary skill in the art may understand the specific meanings of the foregoing terms in the present disclosure according to specific situations.

The present disclosure provides a valve set integrated module. The valve set integrated module may be configured to implement at least one of multiple preset thermal management modes. The preset thermal management modes herein include but are not limited to an air conditioning refrigeration mode, a heat pump heating mode, a battery cooling mode, an air conditioning refrigeration and battery cooling dual-open mode, and a dehumidification mode. Specific working principles of the thermal management modes are described in detail later.

To realize the multiple preset thermal management modes listed above, the thermal management system includes an external heat exchange assembly and a valve set integrated module provided in the present disclosure. The heat exchange assembly includes multiple of a compressor 2, an interior condenser 3, an interior evaporator 5, an exterior heat exchanger 4, and a PTC air heater 7, a blower 8, and a PTC water heater 9.

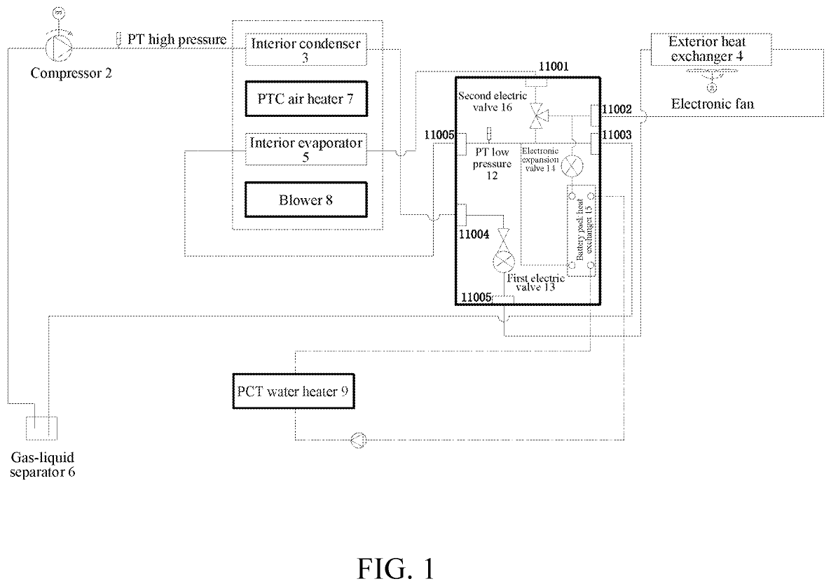

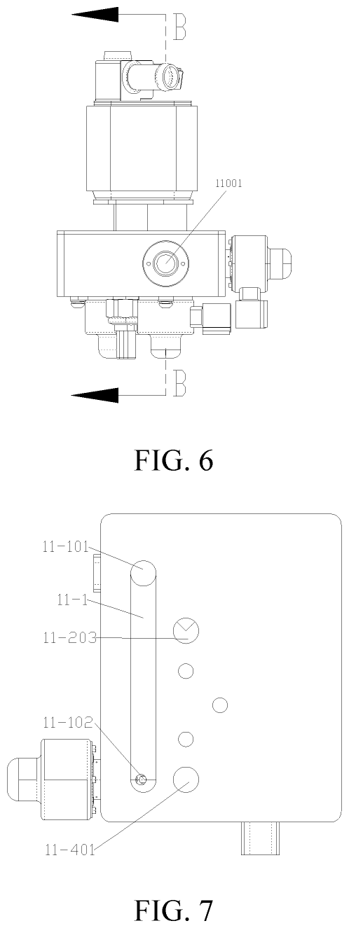

As shown in FIG. 1 to FIG. 9, the valve set integrated module provided by the present disclosure includes a body 11, a first electric valve 13, and a second electric valve 16. The body 11 is provided with multiple internal flow channels and multiple interfaces configured to communicate the internal flow channels with a heat exchange assembly of a thermal management system. In an illustrated implementation, the body 11 is configured to be a block shape to provide an internal flow channel therein. It should be noted that the present disclosure does not limit the configuration of the body 11, as long as providing the internal flow channel therein.

The first electric valve 13 and the second electric valve 16 are arranged on the body 11 and in communication with the internal flow channel. The first electric valve 13 and the second electric valve 16 are configured to be switchable between a blocked/unblocked position and a throttled position. It should be noted that the first electric valve 13 and the second electric valve 16 each refer to a valve body. The valve body may be switched between an unblocking/blocking function and a throttling-induced pressure reducing function as required, or it can be said that the valve body may be configured as a solenoid valve and an expansion valve.

The first electric valve 13 and the second electric valve 16 may be any electric valve capable of switching between the unblocking/blocking function and the throttling-induced pressure reducing function. The first electric valve 13 is used as an example. As described in FIG. 3, the first electric valve 13 may include a spherical valve core 1305, an adjustment base 1307, and an execution motor 1301. The valve core 1305 is provided with a first channel and a second channel for communicating with each other and for communicating with the internal flow channel. The adjustment base 1307 is configured to hold the valve core 1305 in the body 11. For example, the adjusting base 1307 is provided with an external thread, and the body 11 is provided with an internal thread for mating with the external thread. The execution motor 1301 is configured to drive the valve core 1305 to rotate, and with the rotation of the valve core 1305, the first electric valve 13 can realize the switching between the unblocking/blocking function and the throttling-induced pressure reducing function. Further, annular sealing blocks 1304 are arranged on two ends of the first electric valve 13 in a mounting direction to define an interface. The execution motor 1301 is mounted to the body 11 through a screw 1301. The second electric valve 13 may have the same configuration as the first electric valve 16. Details are not described herein again.

In the present disclosure, a first end of the first electric valve 13 is in communication with an interior condenser outlet interface 11004. A second end of the first electric valve 13 is in communication with the exterior heat exchanger inlet interface 11005. A first end of the second electric valve 16 is in communication with an exterior heat exchanger outlet interface 11002. A second end of the second electric valve 16 is selectively communicated with an interior evaporator inlet interface 11001 or a gas-liquid separator inlet interface 11003. The communication herein can be either unblocking/blocking or throttling.

According to the above solution, that is, the present disclosure designs a valve set integrated module having multiple internal passages. The valve set integrated module can communicate the internal flow channel with the heat exchange assembly of the external thermal management system through different interfaces arranged on the body to form multiple different thermal management circuits, and the first electric valve and the second electric valve integrated on the module control the unblocking/blocking or the throttling of the thermal management circuits, to realize multiple preset thermal management modes. The valve set integrated module designed through the above technical solution can reduce the use of a valve control assembly and simplify connection of a pipeline of the thermal management system while realizing multiple thermal management modes, reduce weight of the vehicle, reduce a cost and a fuel consumption, and save space for arranging the vehicle.

Multiple manners may be used to design the internal flow channel. According to an implementation of the present disclosure, the internal flow channel includes an internal flow channel and an external flow channel. It should be noted that the internal and external of the flow channel are relative to the internal and external of the body 11. That is to say, both the internal flow channel and the external flow channel are arranged on the body 11, and do not refer to the connecting pipeline in the thermal management system. The body 11 includes a first portion 1101 and a second portion 1102. The first portion 1101 has a first connecting surface, and the second portion has a second connecting surface. The first connecting surface is hermetically connected with the second connecting surface. That is, the first connecting surface and the second connecting surface are configured to engage with each other. The internal flow channel is arranged inside the first portion 1102. At least one groove is arranged on the first connecting surface of the first portion 1101. The groove on the first connecting surface and the second connecting surface may jointly define the external flow channel.

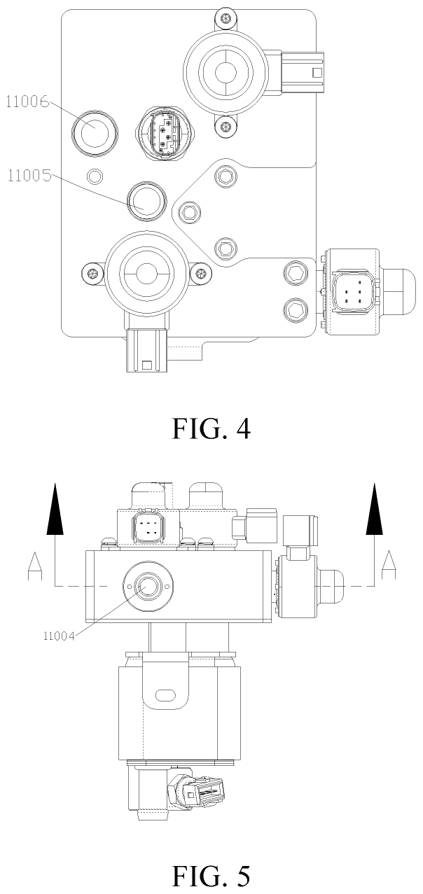

An implementation with three external flow channels and one internal flow channel is shown in FIG. 4 to FIG. 9. An inlet 11-101 of the second electric valve 16 communicates with an inlet 11-102 of the electronic expansion valve 14 to form a first external flow channel 11-1. An outlet 11-203 of the second electric valve 16, a battery pack heat exchanger outlet interface 1501, an interior evaporator outlet interface 11006, a PT sensor low-pressure interface 11-202, and a gas-liquid separator inlet interface 11002 are communicated to form a first internal flow channel 11-2. An outlet 11-301 of the first electric valve 13 and the inlet interface 11005 of the exterior heat exchanger are communicated to form a second internal flow channel 11-3. An outlet 11-401 of the second electronic expansion valve 14 and an inlet 1502 of the battery pack heat exchanger are communicated to form a third internal flow channel 11-4. It should be understood that the above arrangement of the internal flow channel is an exemplary illustration, and any other feasible arrangement of the internal flow channel can also be applied to the present disclosure without interference, which is not limited herein. In addition, it should be noted out that when some implementations do not have corresponding heat exchange assemblies, for example, the battery pack heat exchanger 15 or the PT low pressure sensor 12, the corresponding internal flow channel may be omitted. Further, a cross section of the groove configured to form the external flow channel may be U-shaped, and an area of the sectional surface of the groove is greater than 10% of a valve port area of the first electric valve 13 and the second electric valve 16, so that the refrigerant can flow smoothly from valve ports of the first electric valve 13 and the second electric valve 16 into the external flow channel. In addition, the internal flow channel communicated between an interior evaporator outlet interface 11006 and the gas-liquid separator inlet interface 11003 may be constructed to be a linear flow channel, to reduce the flow resistance of the refrigerant. When the valve set integrated module is provided with a PT low pressure sensor 12, the PT low pressure sensor 12 may be arranged between the interior evaporator outlet interface 11006 and the gas-liquid separator inlet interface 11003. When the internal flow channel communicated between an interior evaporator outlet interface 11006 and the gas-liquid separator inlet interface 11003 may be constructed to be a linear flow channel, the measurement accuracy of the PT sensor 12 may also be improved.

According to an implementation of the present disclosure, as shown in FIG. 1 to FIG. 3, the valve set integrated module may further include a second electronic expansion valve 14 arranged on the body 11. A first end of the electronic expansion valve 14 is in communication with an exterior heat exchanger outlet interface 11002, and a second end of the electronic expansion valve 14 is in communication with a battery pack heat exchanger inlet interface arranged on the body 11. The electronic expansion valve 14 may include a plug-in portion 1401 for inserting into the body 11. The electronic expansion valve 14 and the body 11 are fixedly connected by a threaded pin 1402 through a trailing end of the body 11.

The valve set integrated module may further include a battery pack heat exchanger 15 arranged on the body 11. The battery pack heat exchanger 15 can be connected to the body 11 through a screw 1107. An inlet of the battery pack heat exchanger 15 is in communication with the battery pack heat exchanger inlet interface, and an outlet of the battery pack heat exchanger 15 is connected to a gas-liquid separator. In a manner for mounting the battery pack heat exchanger 15, connecting joints 1103 and 1105 configured to connect with the first end and the second end of the battery pack heat exchanger 15 and O-rings 1104 and 1106 configured to seal the first end and the second end of the battery pack heat exchanger 15 are respectively arranged on the body 11. The battery pack heat exchanger 15 is connected to the body 11 through a threaded fastener.

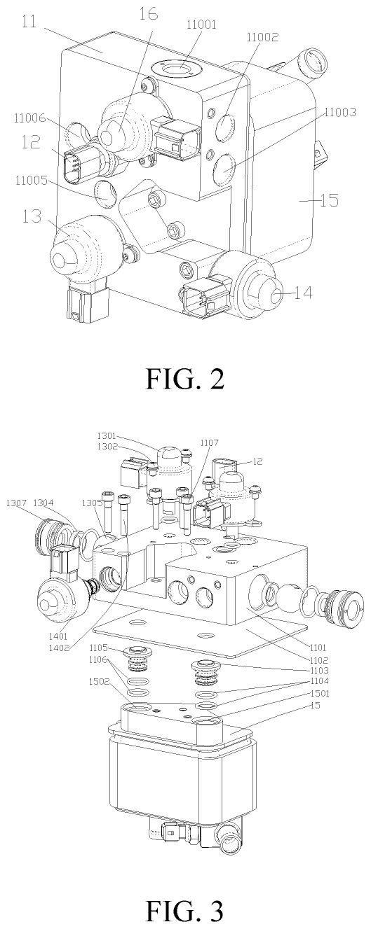

Through the above technical solution, the thermal management mode of battery pack cooling can be further realized. In addition, in the present disclosure, as shown in FIG. 2, the electronic expansion valve 14 and the exterior heat exchanger outlet interface 11002 are assembled on a same side of the body 11, so that the second electric valve 16 and the electronic expansion valve 14 share a same inlet 11002, and ensure that the flow channel connecting the inlet 11-102 of the electronic expansion valve 14 is short, does not form a turning angle, and achieves a low flow resistance design.

The thermal management modes that can be realized by the above technical solution are exemplarily described below in conjunction with FIG. 1 to FIG. 9.

Air-Conditioning Refrigeration Mode:

The compressor 2 discharges a high-temperature and high-pressure gaseous refrigerant and enters the interior condenser 3. After the refrigerant is exothermic and liquefied in the interior condenser 3, the refrigerant passes through the interior condenser outlet interface 11004 and enters the first electric valve 13. In this case, the first electric valve 13 is switched to a solenoid valve and is in an open state. The refrigerant flowing out of an outlet 11-301 of the first electric valve 13 enters an inlet 11-302 of the exterior heat exchanger through the second internal flow channel 11-3, that is, the inlet interface 11005 of the exterior heat exchanger, and enters through the connecting line into the exterior heat exchanger 4. The refrigerant flowing out of the exterior heat exchanger 4 passes through the exterior heat exchanger outlet interface 11002 and enters the second electric valve 16 through the connecting line. In this case, the second electric valve 16 is switched to an expansion valve for use, and the refrigerant flowing out of the second electric valve 16 after throttling-induced pressure reduction flows out of the valve set integrated module through the interior evaporator 11001, and enters the interior evaporator 5 through the connecting pipeline to absorb the ambient heat for evaporation. The cooled ambient temperature blows cold air into the crew compartment through the blower 8 to cool. The refrigerant flowing out of the interior evaporator 5 passes through the interior evaporator outlet interface 11006 and enters the valve set integrated module through the connecting pipeline. The refrigerant enters the gas-liquid separator 6 through the first internal flow channel 11-2 and then enters the gas-liquid separator inlet 11003, and finally returns to the compressor 2, thereby completing an air conditioning refrigeration mode cycle.

Heat Pump Heating Mode:

The compressor 2 discharges a high-temperature and high-pressure gaseous refrigerant, and enters the interior condenser 3 to release heat. The interior condenser 3 releases heat and combines with the PTC air heater 7, and then blows the hot air into the vehicle through the blower 8 to heat the vehicle. After the refrigerant is exothermic and liquefied in the interior condenser 3, the refrigerant passes through the interior condenser outlet interface 11004 and enters the first electric valve 13. In this case, the first electric valve 13 is switched to an expansion valve for use, and after throttling-induced pressure reduction, an outlet 11-301 flowing out of the first electric valve 13 enters an inlet 11-302 of the exterior heat exchanger, that is, an inlet interface 11005 of the exterior heat exchanger, and enters the exterior heat exchanger 4 through the connecting line. The refrigerant flowing out of the exterior heat exchanger 4 passes through the exterior heat exchanger outlet interface 11002 and enters the second electric valve 16 through the connecting line. In this case, the second electric valve is switched to a solenoid valve and is in an open state. The refrigerant flowing out of the second electric valve 16 enters the second internal flow channel 11-3 through the outlet 11-204 of the second electric valve 16, is connected to the gas-liquid separator 6 through the gas-liquid separator inlet 11003, and finally returns to the compressor 2, thereby completing a heat pump heating mode cycle.

Dehumidification Mode:

The compressor 2 discharges a high-temperature and high-pressure gaseous refrigerant and enters the interior condenser 3. After the refrigerant is exothermic and liquefied in the interior condenser 3, the refrigerant passes through the interior condenser outlet interface 11004 and enters the first electric valve 13. In this case, the first electric valve 13 is switched to a solenoid valve and is in an open state. The refrigerant flowing out of an outlet 11-301 of the first electric valve 13 enters an inlet 11-302 of the exterior heat exchanger through the second internal flow channel 11-3, that is, the inlet interface 11005 of the exterior heat exchanger, and enters through the connecting line into the exterior heat exchanger 4. The refrigerant flowing out of the exterior heat exchanger 4 passes through the exterior heat exchanger outlet interface 11002 and enters the second electric valve 16 through the connecting line. In this case, the second electric valve 16 is switched to an expansion valve for use, and the refrigerant flowing out of the second electric valve 16 after throttling-induced pressure reduction flows out of the valve set integrated module through the interior evaporator 11001, and enters the interior evaporator 5 through the connecting pipeline. The refrigerant absorbs heat in the interior evaporator 5 and then cools, circulates the indoor air with the interior evaporator 5 through the blower 8, and the indoor water vapor condenses when passing through the outside of the interior evaporator 5 to achieve the function of dehumidification.

Battery Cooling Mode:

The compressor 2 discharges a high-temperature and high-pressure gaseous refrigerant and enters the interior condenser 3. After the refrigerant is exothermic and liquefied in the interior condenser 3, the refrigerant passes through the interior condenser outlet interface 11004 and enters the first electric valve 13. In this case, the first electric valve 13 is switched to a solenoid valve and is in an open state. The refrigerant flowing out of an outlet 11-301 of the first electric valve 13 enters an inlet 11-302 of the exterior heat exchanger through the second internal flow channel 11-3, that is, the inlet interface 11005 of the exterior heat exchanger, and enters through the connecting line into the exterior heat exchanger. The refrigerant flowing out of the exterior heat exchanger 4 passes through the exterior heat exchanger outlet interface 11002 and enters the valve set integrated module through the connecting line. In this case, the second electric valve 16 is closed, the refrigerant enters the battery pack heat exchanger 15 after being vaporized by the electronic expansion valve 14, and a low-temperature refrigerant exchanges heat with a water circuit to cool the battery pack.

Air Conditioning Refrigeration and Battery Cooling Dual-Open Mode:

The compressor 2 discharges a high-temperature and high-pressure gaseous refrigerant and enters the interior condenser 3. After the refrigerant is exothermic and liquefied in the interior condenser 3, the refrigerant passes through the interior condenser outlet interface 11004 and enters the first electric valve 13. In this case, the first electric valve 13 is switched to a solenoid valve and is in an open state. The refrigerant flowing out of an outlet 11-301 of the first electric valve 13 enters an inlet 11-302 of the exterior heat exchanger through the second internal flow channel 11-3, that is, the inlet interface 11005 of the exterior heat exchanger, and enters through the connecting line into the exterior heat exchanger 4. The refrigerant flowing out of the exterior heat exchanger 4 passes through the exterior heat exchanger outlet interface 11002 and enters the second electric valve 16 through the connecting line. In this case, the second electric valve 16 is switched to an expansion valve for use, and the refrigerant flowing out of the second electric valve 16 after throttling-induced pressure reduction flows out of the valve set integrated module through the interior evaporator 11001, and enters the interior evaporator 5 through the connecting pipeline to absorb the ambient heat for evaporation. The cooled ambient temperature blows cold air into the crew compartment through the blower 8 to cool. The electronic expansion valve 14 is opened, the vaporized refrigerant enters the battery pack heat exchanger 15 after being vaporized by the electronic expansion valve 14, and the low-temperature refrigerant exchanges heat with the water circuit to cool the battery pack.

A second object of the present disclosure is to provide a thermal management system. The system includes an exterior heat exchange assembly of the thermal management system and the valve set integrated module in any of the above implementations. The external heat exchange assembly includes multiple of a compressor 2, an interior condenser 3, an exterior heat exchanger 4, an interior evaporator 5, a gas-liquid separator 6, a PTC air heater 7, a blower 8, and a PTC water heater 9.

A third object of the present disclosure is to provide a vehicle, which includes the thermal management system, and can realize all preset thermal management modes of the thermal management system. Details are not described herein again.

The implementations of the present disclosure are described in detail above with reference to the accompanying drawings. However, the present disclosure is not limited to the specific details in the foregoing implementations, multiple simple deformations may be made to the technical solution of the present disclosure within a range of the technical concept of the present disclosure, and these simple deformations fall within the protection scope of the present disclosure.

Moreover, it should be noted that the specific technical features described in the foregoing specific implementations may be combined in any proper manner in a case without conflict. To avoid unnecessary repetition, various possible combination manners are not described in the present disclosure.

In addition, different implementations of the present disclosure may also be arbitrarily combined without departing from the idea of the present disclosure, and these combinations shall still be regarded as content disclosed in the present disclosure.

What is claimed is:

1. A valve set integrated module, comprising:
a body, provided with a plurality of internal flow channels and a plurality of interfaces configured to communicate the internal flow channels with a heat exchange assembly of an external thermal management system;
a first electric valve and a second electric valve, arranged on the body and in communication with the internal flow channel, the first electric valve and the second electric valve both switchable between a blocked/unblocked position and a throttled position;
a first end of the first electric valve being in communication with an interior condenser outlet interface; a second end of the first electric valve being in communication with an exterior heat exchanger inlet interface; a first end of the second electric valve being in communication with an exterior heat exchanger outlet interface; and a second end of the second electric valve being selectively communicated with an interior evaporator inlet interface or a gas-liquid separator inlet interface.

2. The valve set integrated module according to claim 1, wherein the internal flow channels comprise an internal flow channel and an external flow channel; the body comprises a first portion and a second portion; the first portion has a first connecting surface; the second portion has a second connecting surface; the first connecting surface is hermetically connected with the second connecting surface; a plurality of internal flow channels are arranged inside the first portion; at least one groove is arranged on the first connecting surface of the first portion; and the groove on the first connecting surface and the second connecting surface jointly define the external flow channel.

3. The valve set integrated module according to claim 1, wherein a sectional surface of the groove is U-shaped; and an area of the sectional surface of the groove is greater than 10% of a valve port area of the first electric valve and the second electric valve.

4. The valve set integrated module according to claim 2, wherein a sectional surface of the groove is U-shaped; and an area of the sectional surface of the groove is greater than 10% of a valve port area of the first electric valve and the second electric valve.

5. The valve set integrated module according to claim 1, wherein the internal flow channel communicated between an interior evaporator outlet interface and the gas-liquid separator inlet interface is a linear flow channel.

6. The valve set integrated module according to claim 2, wherein the internal flow channel communicated between an interior evaporator outlet interface and the gas-liquid separator inlet interface is a linear flow channel.

7. The valve set integrated module according to claim 3, wherein the internal flow channel communicated between an interior evaporator outlet interface and the gas-liquid separator inlet interface is a linear flow channel.

8. The valve set integrated module according to claim 4, wherein the internal flow channel communicated between an interior evaporator outlet interface and the gas-liquid separator inlet interface is a linear flow channel.

9. The valve set integrated module according to claim 1, further comprising a PT low pressure sensor, wherein the PT low pressure sensor is arranged between the interior evaporator outlet interface and the gas-liquid separator inlet interface.

10. The valve set integrated module according to claim 2, further comprising a PT low pressure sensor, wherein the PT low pressure sensor is arranged between the interior evaporator outlet interface and the gas-liquid separator inlet interface.

11. The valve set integrated module according to claim 3, further comprising a PT low pressure sensor, wherein the PT low pressure sensor is arranged between the interior evaporator outlet interface and the gas-liquid separator inlet interface.

12. The valve set integrated module according to claim 4, further comprising a PT low pressure sensor, wherein the PT low pressure sensor is arranged between the interior evaporator outlet interface and the gas-liquid separator inlet interface.

13. The valve set integrated module according to claim 5, further comprising a PT low pressure sensor, wherein the PT low pressure sensor is arranged between the interior evaporator outlet interface and the gas-liquid separator inlet interface.

14. The valve set integrated module according to claim 6, further comprising a PT low pressure sensor, wherein the PT low pressure sensor is arranged between the interior evaporator outlet interface and the gas-liquid separator inlet interface.

15. The valve set integrated module according to claim 7, further comprising a PT low pressure sensor, wherein the PT low pressure sensor is arranged between the interior evaporator outlet interface and the gas-liquid separator inlet interface.

16. The valve set integrated module according to claim 1, further comprising an electronic expansion valve arranged on the body, a first end of the electronic expansion valve being in communication with the exterior heat exchanger outlet interface; and a second end of the electronic expansion valve being in communication with a plate-type heat exchanger inlet interface arranged on the body.

17. The valve set integrated module according to claim 1, further comprising a battery pack heat exchanger arranged on the body, an inlet of the battery pack heat exchanger being in communication with a battery pack heat exchanger inlet interface; and an outlet of the battery pack heat exchanger being connected with a gas-liquid separator.

18. The valve set integrated module according to claim 1, wherein the electronic expansion valve and the exterior heat exchanger outlet interface are assembled on a same side of the body.

19. A thermal management system, comprising an external heat exchange assembly of the thermal management system and the valve set integrated module according to claim 1, the external heat exchange assembly comprising a plurality of a compressor, an interior condenser, an exterior heat exchanger, an interior evaporator, a gas-liquid separator, a PTC air heater, a blower, and a PTC water heater.

20. A vehicle, comprising the thermal management system according to claim 19.
